(19) United States
(12) Patent Application Publication
(10) Pub. No.: US 2025/0024225 A1
(43) Pub. Date: Jan. 16, 2025

(54) SYSTEM AND METHOD COMPRISING THE USE OF ADAPTIVE GEOFENCING FOR MOBILITY-BASED APPLICATIONS

(71) Applicant: Zachary Zhao, Cary, NC (US)

(72) Inventor: Zachary Zhao, Cary, NC (US)

(21) Appl. No.: 18/764,652

(22) Filed: Jul. 5, 2024

Related U.S. Application Data
(60) Provisional application No. 63/525,988, filed on Jul. 11, 2023.

(51) Int. Cl. H04W 4/021; H04W 4/02

(52) U.S. Cl. CPC H04W 4/021; H04W 4/027

(57) ABSTRACT

The invention is a system and method of providing adaptive geofencing capable of distinguishing between different modes of transportation (e.g., walking, cycling, driving). Alerts or activities can be triggered when a virtual perimeter is approached or crossed. Geofencing techniques may be used in combination with location-based services to offer actions and/or alerts to a user of the mobile device. The system is further configured to trigger different sets of actions in response to the particular mode of transportation. In some embodiments, the mode of transportation is determined using data from one or more mobile device sensors, including (but not limited to) GPS, accelerometers, gyroscopes, and the like.

### CROSS-REFERENCE TO RELATED APPLICATIONS

This application claims priority to U.S. Provisional Patent Application No. 63/525,988, filed Jul. 11, 2023, the entire content of which is incorporated by reference herein.

### TECHNICAL FIELD

The presently disclosed subject matter is generally directed to a system and method for utilizing sensor data from a mobile device to infer the mode of movement (walking, driving, cycling, etc.) of a user. Specifically, the system includes performing different sets of actions based on the inferred movement status when an associated mobile device crosses into a predefined geofence (virtual boundary).

### BACKGROUND

As portable devices (e.g., smart phones, tablet computers, laptops) become more advanced and powerful, they have been increasingly used to provide locational information to users in real time. More recently, portable devices have introduced a concept known as geofencing. A geofence is defined as a virtual perimeter around a real-world location. Portable devices that implement geofencing functionalities can alert the user when the portable device has entered or exited an established geofence. The perimeter of a geofence can be virtually established around a point of interest, such as an address, store location, and/or residence. Many geofencing applications incorporate geographical information, allowing administrators to define boundaries on a satellite view of a specific physical area. Other applications can define geofence boundaries using longitude and latitude or through user-created and web-based maps. Location data from the mobile device is compared with the coordinate ranges of the geofence to determine the device position relative to the geofence (e.g., inside the geofence, outside the geofence). A user can establish triggers that send a push notification, text message, and/or email alert when a device enters or exits the geofence boundaries. Traditional geofencing systems can therefore trigger certain actions when a device enters or exits a virtual geographic boundary. However, prior art systems do not consider the user's mode of transportation when entering the boundary. Accordingly, it would be beneficial to provide an adaptive, context-aware system that can customize actions based on a user's mode of transportation.

### SUMMARY

The presently disclosed subject matter is directed to a method of targeting a geofence message. Particularly, the method comprises creating a geofence defined by a location parameter. The method includes receiving location data of a mobile device operated by a user. The method includes receiving sensor data quantifying movement of the mobile device, wherein the sensor data is provided by an accelerometer, gyroscope, geomagnetic field sensor, or combinations thereof. The method includes detecting the velocity and acceleration of the mobile device based on the sensor data. The method includes analyzing the velocity and acceleration of the mobile device to identify a transportation mode of the mobile device by comparing the mobile device data to known data associated with walking, biking, driving, riding on a train, and riding in an airplane. The method includes determining whether the mobile device is within the geofence location. The method comprises activating one or more triggering events on a communications hub when the mobile device enters the geofence location.

In some embodiments, the sensors are integrated into the mobile device.

In some embodiments, the method includes receiving information about a user to identify the transportation mode, the information selected from one or more of social media, a user calendar, exercise data, travel patterns, weather, and time of day.

In some embodiments, the triggering events are selected from turning on or off lights within the geofence, opening or closing a door within the geofence, playing or stopping music within the geofence, deactivating or activating an alarm, or combinations thereof.

In some embodiments, the mobile device is selected from a smartphone, tablet computer, laptop, personal digital assistant, smart watch, portable gaming device, personal navigation device, or smart glasses.

In some embodiments, the transportation mode is selected from walking, biking, driving, riding on a train, and riding in an airplane.

In some embodiments, the hub is an automation device capable of performing an action in response to a signal from the mobile device.

In some embodiments, the hub includes a plurality of hubs that integrate with each other.

In some embodiments, the presently disclosed subject matter is directed to a system comprising a processing unit and a memory coupled to the processing unit. The system includes one or more sensors selected from an accelerometer, gyroscope, geomagnetic field sensor, or combinations thereof. The system includes a computer readable storage device coupled to the processor configured to implement a method for targeting a geofence message or take an action based on a transportation mode of the mobile device. The system includes a communication hub in communication with the mobile device, the communication hub configured to activate one or more triggering events when the mobile device enters the geofence location.

In some embodiments, the triggering event is selected from one or more of sending a text message, sending an email, providing communications to the hub to activate an event.

### BRIEF DESCRIPTION OF THE FIGURES

FIG. 1 is a schematic of a system mobile device, hub, and communications protocol in accordance with some embodiments of the presently disclosed subject matter.

FIG. 2 is a schematic of a method of using the disclosed system in accordance with some embodiments of the presently disclosed subject matter.

### DETAILED DESCRIPTION

The presently disclosed subject matter is introduced with sufficient details to provide an understanding of one or more particular embodiments of broader inventive subject matters. The descriptions expound upon and exemplify features of those embodiments without limiting the inventive subject matters to the explicitly described embodiments and features. Considerations in view of these descriptions will likely give rise to additional and similar embodiments and features without departing from the scope of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed packages and methods.

As used herein, the term “and/or” includes any and all combinations of one or more of the associated listed items.

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Embodiments of the present disclosure recognize that currently available geofence systems, methods, and tools lack the ability to target geofence alerts and actions based on the transportation mode of the user. Accordingly, the presently disclosed subject matter is directed to a system and method of providing adaptive geofencing capable of distinguishing between different modes of transportation (e.g., walking, cycling, driving). The term “geofencing” refers to techniques implemented in mobile computing devices wherein virtual perimeters are superimposed onto real geographic areas. Alerts or activities can be triggered when a virtual perimeter is approached or crossed. Geofencing techniques may be used in combination with location-based services to offer actions and/or alerts to a user of the mobile device. The system is further configured to trigger different sets of actions in response to the particular mode of transportation. In some embodiments, the mode of transportation is determined using data from one or more mobile device sensors, including (but not limited to) GPS, accelerometers, gyroscopes, and the like.

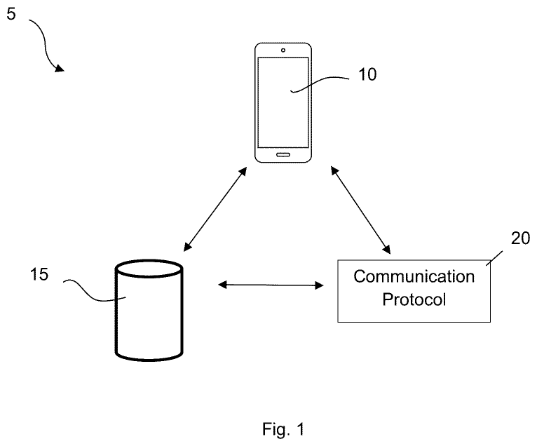

As disclosed in FIG. 1, system 5 includes mobile device 10, hub 15, and communication protocol 20. As set forth in detail below, system 5 is capable of activating geofence messages and/or actions based on a transportation mode of a user accessing the geofence via device 10. The communications protocol can be configured by the user, triggering messages or alerts to device 10 and/or actions performed by hub 15.

Thus, the disclosed system include mobile device 10. The term “mobile device” includes any portable computing device capable of moving or changing locations. Suitable types of mobile devices include (but are not limited to) smartphones, tablet computers, laptops, personal digital assistants (PDAs), smart watches, portable gaming devices, personal navigation devices, smart glasses, and the like. Mobile device 10 can therefore include any device capable of acting as a point of interaction with the geofence described below.

Mobile device 10 is equipped with various sensors that determine the geographic location of the device and detect the user mode of transportation based on the sensor data. For example, the mobile device can include hardware or software measuring devices or sensors capable of identifying the location of the user, the rate of change in the user's location, changes in the user's position, the acceleration of the user and/or the velocity of the user. Specifically, device 10 sensors can include a GPS antenna, accelerometer, gyroscope sensor, geomagnetic sensor, WiFi antenna, and/or any other device capable of measuring the position or change in position of the mobile device. Use and analysis of the recorded measurements obtained by the noted sensors (accelerometer, gyroscope, etc.) assist with identifying a mode of transportation as device 10 enters, exits, or dwells within an active geofence.

The term “global positioning system” (GPS) refers to a satellite-based radio navigation system that provides geolocation and time information to a GPS receiver in mobile device 10. Specifically, a GPS receiver within device 10 can receive signals from a network of satellites to calculate the distance of the mobile device from two or more GPS satellites to determine a particular location. Thus, GPS systems use radio waves between satellites and an internal receiver to provide location and time information for a mobile device.

The term “accelerometer” refers to an electromechanical tool for detecting threshold levels of acceleration or deceleration. An accelerometer measures proper acceleration, which is the acceleration experienced relative to free fall and is the acceleration felt by people and objects. Stated another way, at any point in space/time the equivalence principle guarantees the existence of a local inertial frame, and an accelerometer measures the acceleration relative to that frame.

A gyroscope is an instrument that measures the rate of angular rotation (e.g., an angular rate sensor). Thus, the gyroscope provides orientation of mobile device 10. Optionally, the gyroscope includes a spinning wheel or disc with an axis of rotation that assumes an orientation corresponding to the mobile device. The orientation of the mobile device can be determined by measuring an angular deviation from a reference orientation, the angular deviation being measured along at least one axis in a coordinate system. For example, a mobile device moving at a particular angular velocity can be measured and compared with known angular velocities of different transportation modes, such as walking, bicycling, driving in an automobile, riding a train, or riding in an airplane.

Geomagnetic sensors detect the magnetic field of the Earth (and are commonly referred to as “electronic compasses”). Geomagnetic sensors can determine the direction a mobile device moves by detecting the geomagnetic field. Geomagnetic sensors include 2-axis types (X and Y) and 3-axis models with a Z axis that measures the magnetic force in that direction. Thus, a geomagnetic sensor may enable accurate directional pointing for map orientation and navigation. When combined with an accelerometer and/or a GPS antenna, the movements of a mobile device can be accurately tracked in real time and compared with the expected or simulated movement of a mobile device currently being transported using various modes of transportation to identify the current mode of transportation.

The term “Wi-Fi” refers to a family of wireless network protocols based on the IEEE 802.11 family of standards, which are commonly used for local area networking of devices and Internet access, allowing nearby digital devices to exchange data by radio waves. Wi-Fi is the most widely used computer network in the world, used globally in home and small office networks to link devices together and in public to provide users with internet connectivity.

Optionally, the system can collect additional information to further assist with identifying the mode of transportation being utilized or to verify the conclusions drawn by the system. For example, system 5 can collect information from the user's calendar, email systems, exercise applications, social media, direct messaging applications, SMS text applications, movement history, recent travel patterns, current weather applications, the time of day, and recent modes of travel within the area where the geofence of interest has been created. For example, the time of day and weather may indicate the likelihood of a user to be walking or biking outside. If a mobile device triggers a geofence late at night during a heavy thunderstorm or blizzard, it is much less likely that the user would be walking or bicycling as opposed to driving a motorized vehicle.

The disclosed system and method uses the data collected by mobile device 10 and the associated sensors to draw conclusions about the mode of transportation being used by the user. For example, the system can include data models for the average walking velocity of a person (e.g., 3.1 miles per hour) and the average biking velocity (e.g., 9.6 to 25 mph). The measurements collected by an accelerometer measuring a change in velocity at a high rate can further indicate that the mobile device is in a vehicle. The information can be collected from mobile device 10, recorded in a database or network accessible repository, and further transmitted to an analytics module. Analyzing the measurements of the mobile device sensors therefore identifies a mode of transportation of mobile device 10.

The disclosed system can include a server module configured to load or transmit one or more active geofences to mobile device 10. The device connecting to the system may retrieve, store, download or actively stream the geofence data of the geofences over a network.

The system also includes a smart home hub or equivalent device capable of receiving signals from the mobile device and triggering a set of actions based on the received information. For example, the actions can include door locks, garage door openers, lighting system, and the like. Thus, the system can push one or more notifications to the mobile device, triggering the transitioning conditions of the geofence using the mode of transportation designated by the geofence's parameters when the geofence was created. The geofence message may be sent to the mobile device using push notifications, emails, short messaging service (SMS) data, and/or direct messaging service data.

Hub 15 can include any automation device capable of performing an action in response to a signal from a mobile device or other communication network. In some embodiments, the integrated devices of the smart home environment can include a plurality of hubs 15 that integrate seamlessly with each other in a network and/or with a central server or a cloud-computing system to provide a variety of useful functions. For example, the environment within the geofence can include one or more intelligent, multi-sensing, network-connected thermostats, doorbells, appliances, cameras, lights, alarms, door locks, door openers, door closers, and the like.

Hub 15 can include smart environments for homes, such as single-family houses, duplexes, townhomes, multi-unit apartment buildings, hotels, retail stores, office buildings, industrial buildings, and the like. Thus, the smart environment can broadly include any living space or workspace.

By virtue of network connectivity, one or more of the hubs can allow a user to interact with the device even if the user is not proximate to a hub. For example, a user may communicate with a hub using mobile device 10 to directly trigger an event (e.g., manually disarm an alarm). A webpage or application may be configured to receive communications from the user and control the device based on the communications and/or to present information about the device's operation to the user. For example, the user may view a current set point temperature for a device (e.g., a stove) and adjust it using a computer. The user may be in the geofence during this remote communication or outside the structure.

The system includes a communications protocol that provides a secure and reliable method for the mobile device to transmit its location and mode of transportation to the hub. The communications protocol can include Wi-Fi, Bluetooth®, cellular data, or any other suitable protocol.

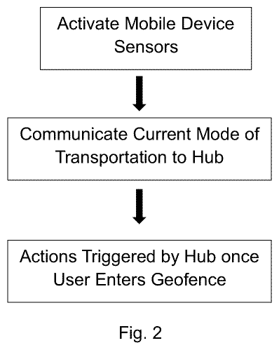

In use, mobile device 10 uses one or more sensors to detect a user's mode of transportation. The detection can include analyzing speed and pattern of movement data. As shown in the schematic of FIG. 2, when the mobile device enters a predefined geofenced area, it communicates a current mode of transportation to the hub. Upon receiving the information, hub 15 triggers a set of actions corresponding to the detected mode of transportation. The actions can be determined by the communications protocol set by a user. For example, if the user is detected as driving a vehicle, the hub can send a signal to open a garage door. The disclosed system thereby provides a reliable and flexible solution for triggering contextually appropriate actions based on the inferred mode of movement and location of a user.

The disclosed system and method offer many advantages over prior art systems. For example, by providing accurate information on the mode of transportation of a user, an associated hub or communications device can more precisely direct an action to occur in response to the user location.

The disclosed system is easy to use, requiring only that a user carry a mobile device to accurately detect a location and mode of transportation.

The system as described herein allows for more precise actions to be taken by the hub and/or communications module based on the identification of the user and/or location from a particular location.

Exemplary embodiments of the methods and components of the presently disclosed subject matter have been described herein. As noted elsewhere, these embodiments have been described for illustrative purposes only, and are not limiting. Other embodiments are possible and are covered by the presently disclosed subject matter. Such embodiments will be apparent to persons skilled in the relevant art(s) based on the teachings contained herein. Thus, the breadth and scope of the present invention should not be limited by any of the above-described exemplary embodiments but should be defined only in accordance with the following claims and their equivalents.

### Examples

### Prophetic Example 1

### Residential Setting

A user carrying a smartphone or other mobile device is traveling to their residence. The disclosed system detects the user and determines that the user is driving when the user enters the geofenced area. The system communicates the user's location and mode of travel to the communications hub. In response, the system opens the user's home garage door, turns on the lights in the user's driveway, and unlocks the door to the residence.

If the user is detected as walking, the system can unlock the front door and turn on the foyer lights.

If the user is detected as cycling, the system can unlock the back door where bicycles are typically stored.

### Prophetic Example 2

### Factory Setting

Workers arriving at a factory can be identified and authenticated based on their smartphones. If a worker arrives by car, the disclosed system can raise a barrier arm at the factory to allow entry. If a worker arrives on foot, the system can open a pedestrian entrance to allow the worker to enter the facility.

### Prophetic Example 3

### Commercial Setting

A shopping center can use the disclosed system to guide cars to available parking spots when a car is detected. Similarly, the system can guide pedestrians to the nearest entrance if they are walking.

What is claimed is:

1. A method of targeting a geofence message, the method comprising:
creating a geofence defined by a location parameter;
receiving location data of a mobile device operated by a user;
receiving sensor data quantifying movement of the mobile device, wherein the sensor data is provided by an accelerometer, gyroscope, geomagnetic field sensor, or combinations thereof;
detecting a velocity and acceleration of the mobile device based on the sensor data;
analyzing the velocity and acceleration of the mobile device to identify a transportation mode of the mobile device by comparing the mobile device data to known data associated with walking, biking, driving, riding on a train, and riding in an airplane;
determining whether the mobile device is within the geofence location;
activating one or more triggering events on a communications hub when the mobile device enters the geofence location.

2. The method of claim 1, wherein the sensors are integrated into the mobile device.

3. The method of claim 1, further comprising receiving information about a user to identify the transportation mode, the information selected from one or more of social media, a user calendar, exercise data, travel patterns, weather, and time of day.

4. The method of claim 1, wherein the triggering events are selected from turning on or off lights within the geofence, opening or closing a door within the geofence, playing or stopping music within the geofence, deactivating or activating an alarm, or combinations thereof.

5. The method of claim 1, wherein the mobile device is selected from a smartphone, tablet computer, laptop, personal digital assistant, smart watch, portable gaming device, personal navigation device, or smart glasses.

6. The method of claim 1, wherein the transportation mode is selected from walking, biking, driving, riding on a train, and riding in an airplane.

7. The method of claim 1, wherein the hub is an automation device capable of performing an action in response to a signal from the mobile device.

8. The method of claim 1, comprising a plurality of hubs that integrate with each other.

9. A system comprising:
a processing unit and a memory coupled to the processing unit;
one or more sensors selected from an accelerometer, gyroscope, geomagnetic field sensor, or combinations thereof;
a computer readable storage device coupled to the processor configured to implement a method for targeting a geofence message or take an action based on a transportation mode of the mobile device;
a communication hub in communication with the mobile device, the communication hub configured to activate one or more triggering events when the mobile device enters the geofence location.

10. The system of claim 9, wherein the triggering event is selected from one or more of sending a text message, sending an email, providing communications to the hub to activate an event.

11. The system of claim 9, wherein the event is selected from turning on or off lights within the geofence, opening or closing a door within the geofence, playing or stopping music within the geofence, deactivating or activating an alarm, or combinations thereof.

12. The system of claim 9, wherein the sensors are integrated into the mobile device.

13. The system of claim 9, further comprising information to identify the transportation mode, the information selected from one or more of social media, a user calendar, exercise data, travel patterns, weather, and time of day.

14. The system of claim 9, wherein the triggering events are selected from turning on or off lights within the geofence, opening or closing a door within the geofence, playing or stopping music within the geofence, deactivating or activating an alarm, or combinations thereof.

15. The system of claim 9, wherein the mobile device is selected from a smartphone, tablet computer, laptop, personal digital assistant, smart watch, portable gaming device, personal navigation device, or smart glasses.

16. The system of claim 9, wherein the transportation mode is selected from walking, biking, driving, riding on a train, and riding in an airplane.

17. The system of claim 9, wherein the hub is an automation device capable of performing an action in response to a signal from the mobile device.

18. The system of claim 9, comprising a plurality of hubs that integrate with each other.
